(19) United States
(12) Patent Application Publication
(10) Pub. No.: US 2008/0126261 A1
(43) Pub. Date: May 29, 2008

(54) Cashless vending system and method

(76) Inventor: Robert Lovett, Finger, TN (US)

Correspondence Address: JAMES RICHARDS, 58 BONING RD, FAYETTEVILLE, TN, 37334, US

(21) Appl. No.: 11/604,158

(22) Filed: Nov. 25, 2006

(51) Int. Cl. G06Q 20/00; G07B 15/00; H04L 9/00

(52) U.S. Cl. 705/72; 705/17; 705/13; 705/64

(57) ABSTRACT

A system and method for activating a vending machine utilizing a wireless link to a cell phone in conjunction with a security feature using a finger print reader or personal identification number (PIN). An account is established with a payment processing center (PPC) who oversees the movement and distribution of payments from a cell phone account to a vending machine account. Account information is maintained in the cell phone and in the vending machine and may be communicated to the PPC at a later time after the transaction. The wireless link may be Bluetooth®, Zigbee®, infrared, or other short range wireless technology.

### BACKGROUND

1. Field of the Invention

The present invention pertains generally to the field of vending machines and processes, more particularly to the field of cashless vending systems and processes.

2. Background of the Invention

Vending machines typically comprise automated, point-of-sale mechanical or electronic devices that dispense products such as cold drinks and candy bars, or a service such as parking time on automobile parking meters. Vending machines typically accept cash in the form of coins or bills. Some machines now accept credit cards, radio frequency identification (RFID) cards. Vending machines have traditionally been used for the automated sale of food and beverages, but with the recent introduction of credit cards, items such as stamps, movie tickets, and high priced cameras and even over the counter drugs where pharmacies are not readily available.

Today's vending machines have several shortcomings. Cash machines are subject to cash handling issues. Cash machines require the exact change, or a coin changer. Coin changers are bulky, costly to purchase and maintain since they require frequent on-site service. Cash machines also handle a large amount of cash—attracting vandals and thieves. Thieves may steal an entire machine just to get the cash it stores. Credit card machines are subject to credit card issues. Credit card machines must have a telephone link for credit card verification, often limiting the locations available for a machine. The phone line cost and credit card charges narrow the profit margin for the machine, especially a small machine. Further, credit card readers are easily jammed by irate customers and require periodic field maintenance.

Thus, what is needed is a cashless system for vending machines that does not require a phone line connection and does not compromise data security of the purchase transaction between the vending machine and customer.

### BRIEF DESCRIPTION OF THE INVENTION

Briefly, the present invention relates to a system and method for activating a vending machine utilizing a wireless link to a cell phone in conjunction with a security feature using a finger print reader or personal identification number (PIN). An account is established with a payment processing center (PPC) who oversees the movement and distribution of payments from a cell phone account to a vending machine account. Account information is maintained in the cell phone and in the vending machine and may be communicated to the PPC at a later time after the transaction. The wireless link may be Bluetooth®, Zigbee®, infrared, or other short range wireless technology.

In one embodiment, a street parking meter may communicate with the cell phone on a wireless link to start or stop the meter.

In one embodiment, an in-car parking meter may be used. The in-car meter includes a display, on/off switch and clock and may include a wireless transceiver.

In one embodiment, an in-car parking meter may be used. The in-car meter includes a display, clock and wireless transceiver and may be activated by a wireless transceiver contained in a cell phone or in a standalone street meter.

In one embodiment, a beverage, food, or other vending machine may be activated by a cell phone wireless link.

In one embodiment, a restaurant such may use the cell phone wireless link for payment processing over the counter or drive through lanes.

In one embodiment, a public transportation ticket system such as busses or subway trains may be activated by the wireless cell phone link.

In one embodiment, funds may be exchanged between two individuals such as a taxi fare or beauty salon or sharing the cost of dinner in a restaurant by using the cell phone wireless link.

These and further benefits and features of the present invention are herein described in detail with reference to exemplary embodiments in accordance with the invention.

### BRIEF DESCRIPTION OF THE FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 shows a system block diagram of an exemplary vending system in accordance with the present invention.

FIG. 2 shows a functional block diagram of an exemplary vending machine in accordance with the present invention.

FIG. 3 shows a soft drink vending machine that has been converted or adapted to use the present invention.

FIG. 4 and FIG. 5 comprise a flow chart illustrating the steps required from account activation to transaction completion of a purchase from the vending machine in accordance with the present invention.

FIG. 6 shows an exemplary parking meter in accordance with the present invention.

FIG. 7 shows the meter on a pole with a meter number posted on the pole.

FIG. 8 is a flow chart illustrating the steps required for utilizing the present invention to both park and exit a street parking meter.

FIG. 9 shows a vending machine that vends high priced items such as cameras, cell phones, perfume and over the counter drugs.

FIG. 10 illustrates the entry way to a public transportation system that has short range wireless readers for issuing tickets.

FIG. 11 illustrates a fast food restaurant with a short range wireless transceiver connected to a Point of Sale (POS) system for processing food orders for both over the counter and drive through.

FIG. 12 illustrates a piconet interconnecting a group of vending machines being approached by a buyer with a cell phone.

FIG. 13 illustrates an in-car parking meter in accordance with the present invention.

FIG. 14 shows the rear view of FIG. 13 with display alternately displaying the remaining time and the meter number.

FIG. 15 illustrates an alternative in-car meter in accordance with the present invention.

FIG. 16 shows the rear view of FIG. 15 with display alternately displaying the remaining time and the meter number.

FIG. 17 illustrates an exchange of money by two users with short range wireless link enabled cell phones in conjunction with a cellular tower.

FIG. 18 shows an exemplary code table.

FIG. 19 shows a vending machine code table and shows a first and second synchronizing data sequence.

FIG. 20 shows a first cell phone account number being encrypted with a PIN 19:44.

FIG. 21 shows a second cell phone account number being encrypted with a PIN 86:24.

FIG. 22 shows the first cell phone account number being decrypted at the vending machine.

FIG. 23 shows the second cell phone account number being decrypted at the vending machine.

FIG. 24 and FIG. 25 illustrate exemplary steps for operating a vending machine using a PIN in accordance with the present invention.

### DETAILED DESCRIPTION OF THE INVENTION

The present invention relates to a system and method for improving the speed, ease, and security of operating an automobile parking meter, a beverage vending machine, a transportation ticket machine or related services using information communicated over a short range wireless cell phone link.

The system requires no cash or coins or credit cards or other special cards at the meter or vending machines. The parking meter or vending machines need not be connected to a landline or cell phone or WI-FI or otherwise be connected to any additional communications link. This will allow low cost installation and may fit into existing configurations. No monthly fees are needed for a communications link from the vending machine to the PPC. The location of the vending machine is unrestricted by any need for a telephone line. Upgrade of most machines to include the invention is likely possible simply by replacing a controller module.

As a further advantage, the cell phone may be used to purchase items from a vending machine that is outside the range of a cell tower. Since account information is maintained in the vending machine and/or cell phone and the transaction is made based on stored information, immediate or contemporaneous (within a few minutes, for example, 10 minutes) contact with the PPC is not required. Thus, a vending machine remote from a cell tower or deep within a building may complete transactions by communicating with the cell phone using the short range wireless link and stored transaction information may be communicated later to the PPC via any convenient route.

In accordance with the invention, the cell phone has an encrypted account established by the PPC. Account information is stored in the memory of the cell phone. The wireless link is used to transfer funds and other account information from the cell phone to the parking meter, vending machine, transportation authority, or other party during each purchase or transaction. The transaction information may later be transferred to the PPC by vendor personnel by downloading from the vending machine during regular stocking of the vending machine and transferring the downloaded transaction information to the PPC when the vendor arrives back at the warehouse.

Cell phones are increasingly adopting Bluetooth® as a short range wireless link for downloading picture files, configuration files, email, and other information to a computer or other device. Bluetooth® is presently a preferred wireless link for the present invention; however, other wireless links may be used such as Zigbee®, infrared, and others. Given the rapid evolution of wireless technology, some presently unknown wireless interface may be adopted as the most popular standard in the future. It is contemplated that any short range wireless link may be adapted to the present invention. Within this disclosure, wireless link, wireless data link, short range link and similar terms refer to the short range links like Bluetooth® with a range typically 10 meters or less. Cell phone link, cell phone network and similar terms refer to the cell phone communications path using such standards as GSM, PCS, AMPS and others, with a range of typically five to ten kilometers. Cell phone networks may typically carry voice or data. A cell phone having both the cell phone link and short range link capability is contemplated to be used with the present invention. The term cell phone is contemplated to include any hand held computing device incorporating the cell phone link capability.

Cell phones are also beginning to incorporate fingerprint reader devices for security. Fingerprint readers often take the place of a PIN, speeding the initiation of a transaction and freeing the user from having to remember yet another PIN or password, which may be easily compromised. In accordance with the present invention, a fingerprint reader may be used as part of a security feature for initiating a transaction. In a further embodiment, data from the fingerprint reader may be used as part of an encryption technique. In yet another embodiment, an encryption technique is disclosed that uses a PIN.

The present invention will now be described in greater detail with reference to the drawings.

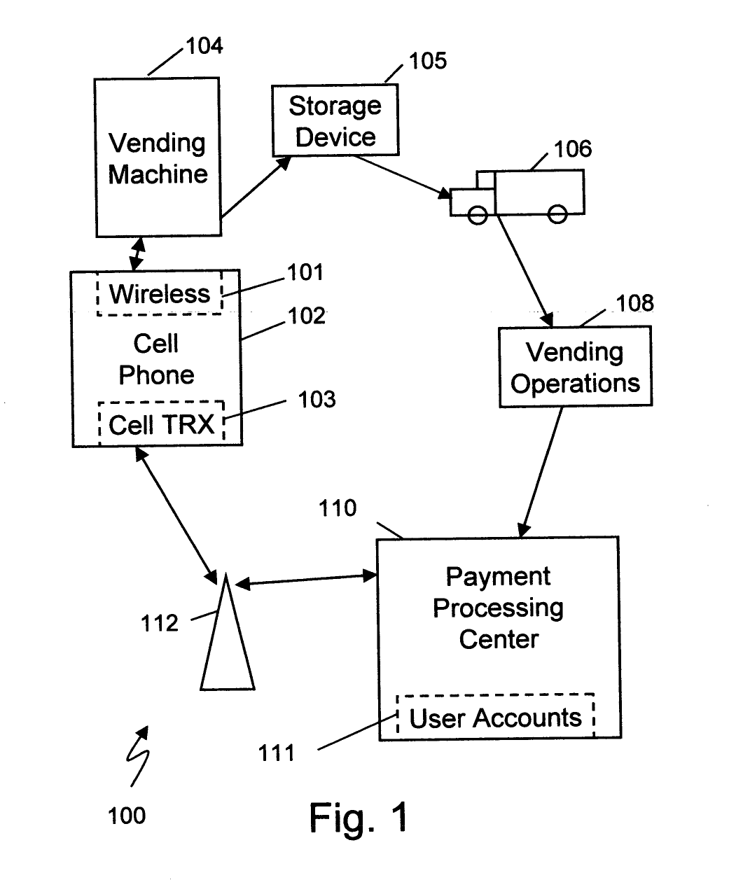

FIG. 1 shows a system block diagram of an exemplary vending system in accordance with the present invention. Referring to FIG. 1, the system 100 comprises a cell phone 102 with a short range wireless link 101 which may communicate with a vending machine 104. The cell phone 102 is used to command the vending machine 104 and encrypted transaction data is recorded on the cell phone 102 and the vending machine 104.

A prospective customer first establishes an account 111 with a payment processing center (PPC) 110. The account establishes a spending limit in accordance with a credit limit or prepaid amount. When the customer uses the cell phone 102 to purchase a product from the vending machine 104, an encrypted copy of the transaction is stored in the vending machine 104 and in the cell phone 102. When the vendor 106 stocks the machine, the vendor 106 may read the memory of the vending machine 104 and download all cell phone transaction information to a storage device 105. The vendor 106 then takes the transaction information to a warehouse 108, where the transaction information is loaded onto a computer and communicated to the payment processing center 110. The payment processing center may then apply the transaction information to the account. Typically, this means subtracting the sale price from the customer account and adding the sale price to the vending machine company's account. Other transactions may also be performed. In an alternative embodiment, the payment processing center 110 may be at the warehouse 108 and/or the vending company and payment processing company may be the same company. One advantage of transferring data to the vendor when the machine is stocked is that monthly phone charges for a line to the vending machine are eliminated

The customer also receives a copy of the transaction information to maintain account status information in the cell phone 102. Account balance and funding or credit limits may be displayed at the cell phone 102. The customer may periodically report transactions to the PPC through a cell phone network 112 using the cell phone transceiver 103, providing a duplicate of the vendor's reports. If the cell phone 102 is lost or damaged, the transaction will still be reported via the vendor. Likewise, if the vending machine 104 is damaged or stolen, the transaction will still be reported by the customer. The customer should be required to periodically report to the PPC to maintain funding status and confirm transactions on the account.

Thus, a customer may purchase an item from a vending machine without the need for contact with the PPC until some convenient time after (for example, one hour, one day, or one week) the product is delivered to the customer—freeing the transaction from phone lines or cell phone coverage at the vending location and allowing numerous remote locations not otherwise available for vending.

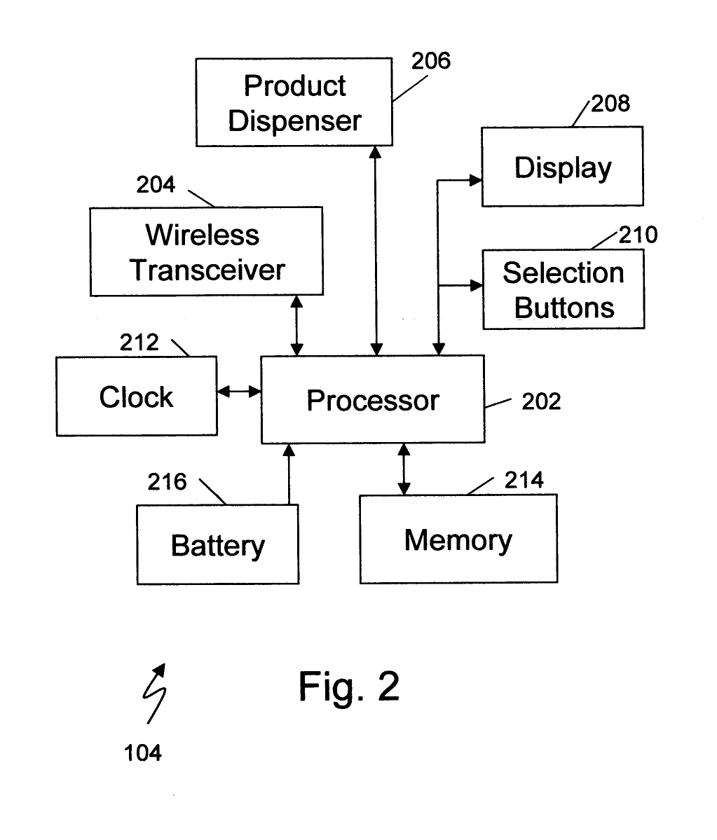

FIG. 2 shows a functional block diagram of an exemplary vending machine in accordance with the present invention. Referring to FIG. 2, the vending machine 104 comprises a processor 202 with associated memory 214 and clock 212, a product dispenser 206, a display 208, and a short range wireless transceiver 204. Operation of the vending machine 104 is centered around the processor 202. The processor 202 reads the selection buttons 210 and controls the product dispenser 206 accordingly. The processor 202 may also maintain an inventory account and may control a coin changer, if provided (not shown). The processor also interfaces with the short range wireless link 204 to process wireless link sales. The processor 202 may interface with the clock 212 to record the date and time of each transaction. The clock 212 may also be used as part of a data encryption process. In some applications, a battery 216 may be provided for stand alone operation. The processor 202 typically includes memory 214 and may include some form of non-volatile memory for storing transaction information safe from power interruptions. A display 208 may be provided to indicate product price, stock status, or transaction status.

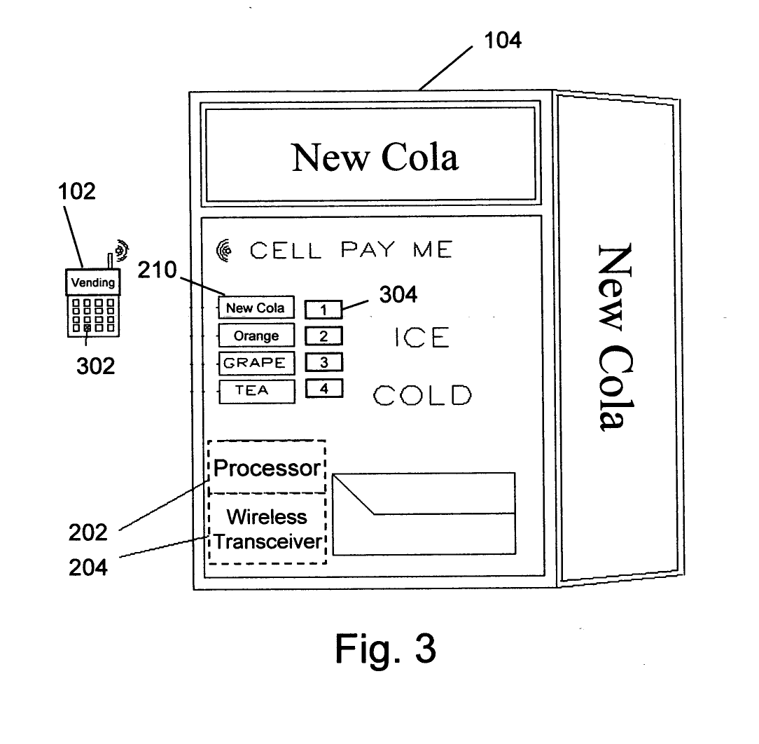

FIG. 3 shows a soft drink vending machine 104 that has been converted or adapted to use the present invention. FIG. 3 shows the selection buttons 210 on the vending machine 104 and selection numbers 304 that may be used to select product via the cell phone 102.

In accordance with the invention, the product selection may be performed by pressing a selector button 210 on the vending machine 104 or by selecting the product on the cell phone 102. To support selection by cell phone 102, the vending machine 104 may send product selection information to the cell phone 102 so that the cell phone 102 may link cell phone buttons to the different products and provide a product list. The customer may then scroll through the list and select the desired product.

Alternatively, the vending machine may have product numbers 304 shown associated with the product label on the vending machine. The product may be selected by entering the appropriate product number 304 in the cell phone 102. One or more of the above selection methods may be offered at a given installation.

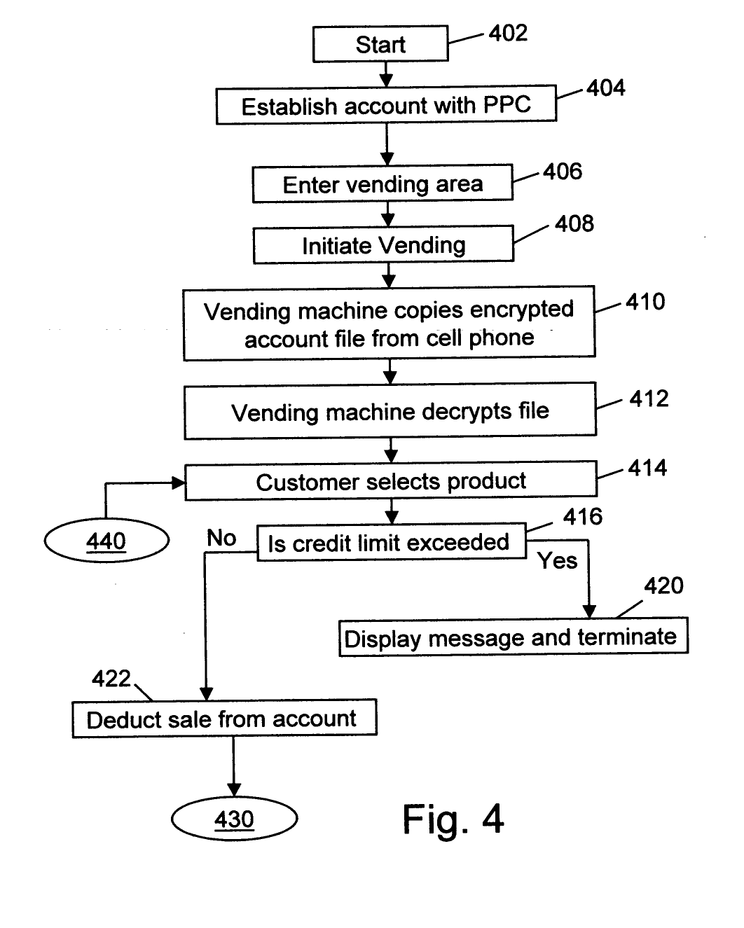

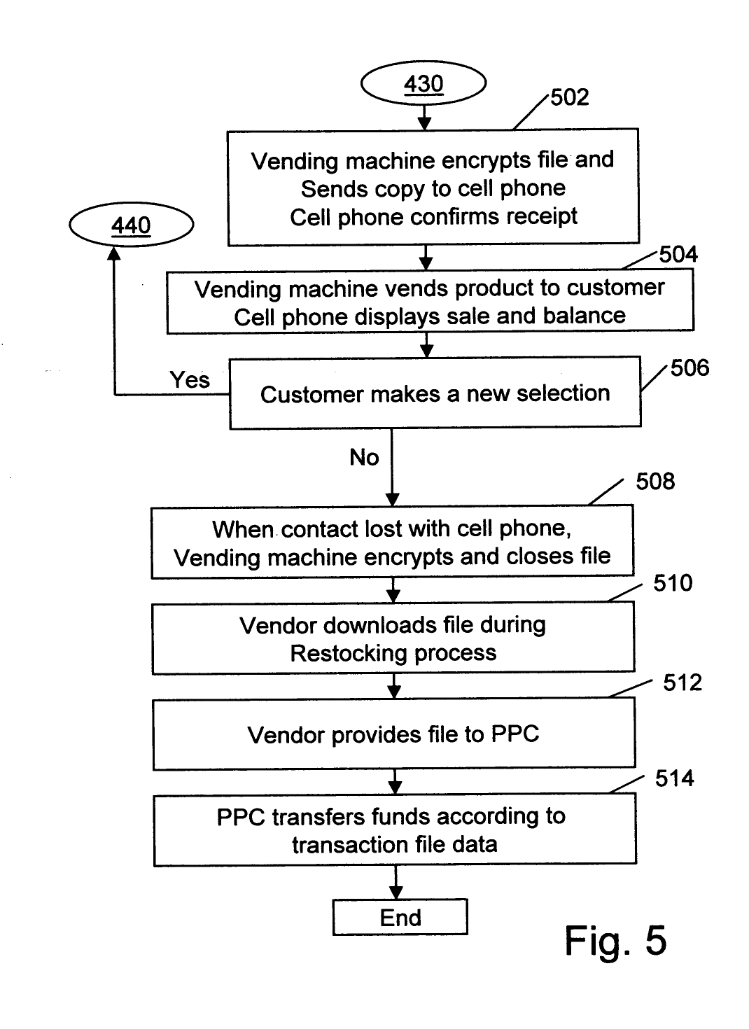

FIG. 4 and FIG. 5 comprise a flow chart illustrating the steps required from account activation 402 to transaction completion 514 of a purchase from the vending machine in accordance with the present invention.

Referring to FIG. 4, the customer first establishes 404 an account with the PPC. The PPC may be operated by the vending company or may be a separate entity. As a separate entity, the PPC may serve multiple vending companies. Also, multiple PPC's may be used with a given vending machine since PPC identification information may be included in each transaction data file.

The account may be a prepaid account or a credit account. The account may be tied to a bank account or credit card or other financial arrangements may be made between the customer and the PPC. Appropriate information such as credit limit for credit accounts, or balance for prepaid accounts may be maintained in the cell phone and provided for each transaction.

Once the account is established, the account may be used for any number of transactions over any period of time as allowed by the PPC.

To initiate a transaction, the customer enters 406 the vending area and comes within range of the cell phone wireless link, which may typically be 10 meters or less.

The customer then initiates vending 408 by activating the vending feature of the cell phone. In one embodiment, the cell phone includes a fingerprint reader, and the customer presses the finger print reader to verify the user's identity and enable the vending account and vending features. Fingerprint data may also be used to encrypt account information. In another embodiment, a PIN may be entered to enable vending features.

The customer then presses the vend key on the cell phone to activate the soft drink vending machine's short range wireless transceiver. By pressing the vend key the user grants permission to the vending machines transceiver to copy 410 an encrypted file from the cell phone's memory. The machine's processor 202 will decrypt 412 the file to discover the user's payment history and the maximum dollar amount that can be spent at this point in time.

The vending machine now awaits the product selection 414 via the cell phone or selection buttons, as provided for in the particular installation. When the user presses the selection button, the machines processor 202 will check 416 the credit limit, and if exceeded, display 420 a message and terminate the transaction. If not exceeded, the processor will subtract 422 the cost of the item selected from the users account, then add a date and time stamp and the unique identifier of the vending machine and then (continuing on FIG. 5 through the 430 connection) encrypt 502 the file and immediately send a copy back to the user's cell phone memory. Next the machine will vend 504 the product. This sequence is necessary to prevent the user from deleting a record of the transaction by turning off the cell phone to prevent the vending machine from sending the file back to their cell phone.

As long as the customer remains in the area, the customer's cell phone account will remain open. If the customer makes 506 a second selection (repeat steps through the 440 connection to FIG. 4), the machine's processor 202 will then, prior to vending the second item, subtract 422 the price for the second item and return an updated file containing both purchases to the user's cell phone file. The vending machine will then deliver 504 the product.

When the customer leaves the area and communication is lost 508 with the cell phone, the vending machine will encrypt and close the transaction data file and store the file in memory for later retrieval by the vendor.

When the machine's products are replenished a copy of the transaction data file will be downloaded 510 by the vendor sales representative. The files may then be forwarded 512 to the PPC for payment at first opportunity, typically when the vendor sales representative returns to the warehouse. The PPC will then decrypt the file and move 514 the price of the vend item(s) from the customer's account to the vending company's account.

The transaction data file information may include the following information, by way of example and not limitation:

| | | |
|---|---|---|
| 1] | Cell Phone Number | 555 000 0000 |
| 2] | Account # | 48839723037 |
| 3] | PPC ID | 33445566998877 |
| 4] | Credit Limit | $25.00 Based on credit history/ |
| | | FICA score |
| 5] | Date/Time/Stamp | 9/6/2006 9:18:26 PM |
| 6] | Product sold | New Cola 16 oz |
| 7] | Purchase Amount | $5.45 |
| 8] | Age (Alcohol/Tobacco/Lottery) | 27 |
| 9] | Account privileges, discounts | |
| 10] | Promotional coupons | |
| 11] | Number of purchases 12 | |
| 12] | Vending Machine Number | 123456789 |
| 13] | Remote inventory reporting | 78 16 OZ Bottles |
| 14] | Coins | $78.50 |
| 15] | 1.00 Bills | $24 |
| 16] | 5.00 Bills | $4 |
| 17] | Credit Cards | $37.00 |

The cell phone number and account number identify the customer and account respectively. The PPC ID identifies the payment processing center where the account is maintained. The credit limit identifies the remaining finds available for future purchases. The date/time stamp is the date and time of the transaction. The product sold and purchase amount are for the transaction.

Customer's age may be provided if the customer wishes to buy age limited products such as alcohol and tobacco. (One embodiment uses fingerprint data to enable the transaction; thus, the cell phone cannot be given to an underage person to buy the product).

Account privileges and discounts may also be provided. Number of purchases may be recorded and may be used to offer coupons and discounts.

In a further embodiment, the vending company may gather spending pattern data on the customer and may send the customer advertisements and special offers, such as discount coupons that may be used as payment or part payment through the system.

The vending machine number and owner information may also be provided. The information reported may also include other information such as machine inventory or service status or other information that is useful to the vending company.

In one embodiment, the account information is encrypted using fingerprint data from the fingerprint reader. A fingerprint is recognized using minutiae points. The minutiae points are the points of intersection of the lines of the fingerprint. The minutiae point information may be used as part of an encryption code. The encryption may use a two part code. One half will be the finger print minutia file and the other half will be held in the vending machine only. For example:

| Vending Machine Key | Minutiae Points |
|---|---|
| 83645782945732904 | 8839164532759052190757215829595223237523984 |

When the customer presses a finger to the fingerprint reader, the cell phone's short range wireless transceiver will send the Minutiae Points to the vending machine. This also authorizes the vending machine to copy your account file from cell phone. This method will prevent someone close by from intercepting the short range transceiver file data during transmission to the vending machine.

In one embodiment, the vending machine key and the minutiae points may be used together as a key or password for a data encryption method to encrypt transaction data. The two keys may be concatenated or summed or otherwise combined and used as a password for a conventional encryption method.

In an alternative embodiment, other forms of encryption may be used as are known in the art.

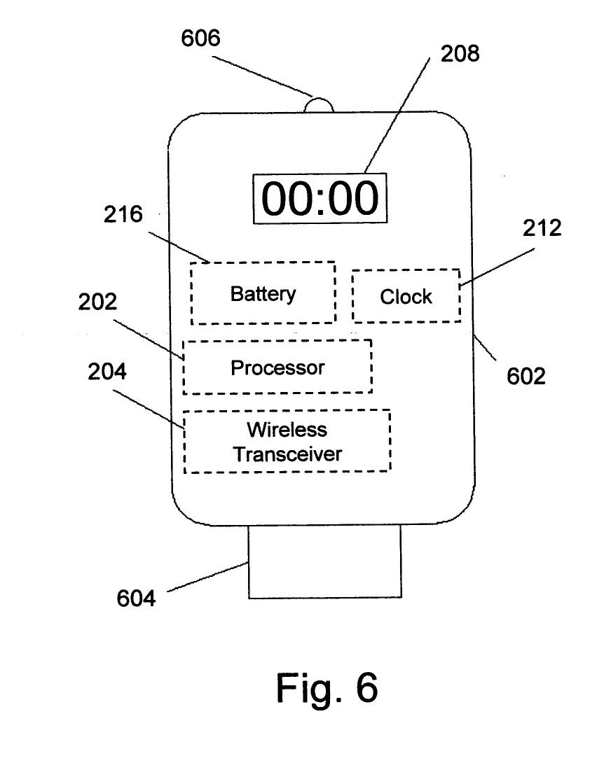

FIG. 6 shows an exemplary parking meter in accordance with the present invention. The parking meter of FIG. 6 may provide a number of services related to parking time. Referring to FIG. 6, the parking meter 602 comprises a display 208 for showing the time remaining, a processor 202 for processing the account information and running the meter display 208, and a clock 212 and battery 216. The parking meter 602 includes a short range wireless interface 204 for communicating information to the user's cell phone 102. The meter 602 may also include one or more light emitting diodes (LED)'s 606 to indicate status such as valid and expired parking time. The meter 602 may include a mounting flange 604 or other means for attaching to a meter pole.

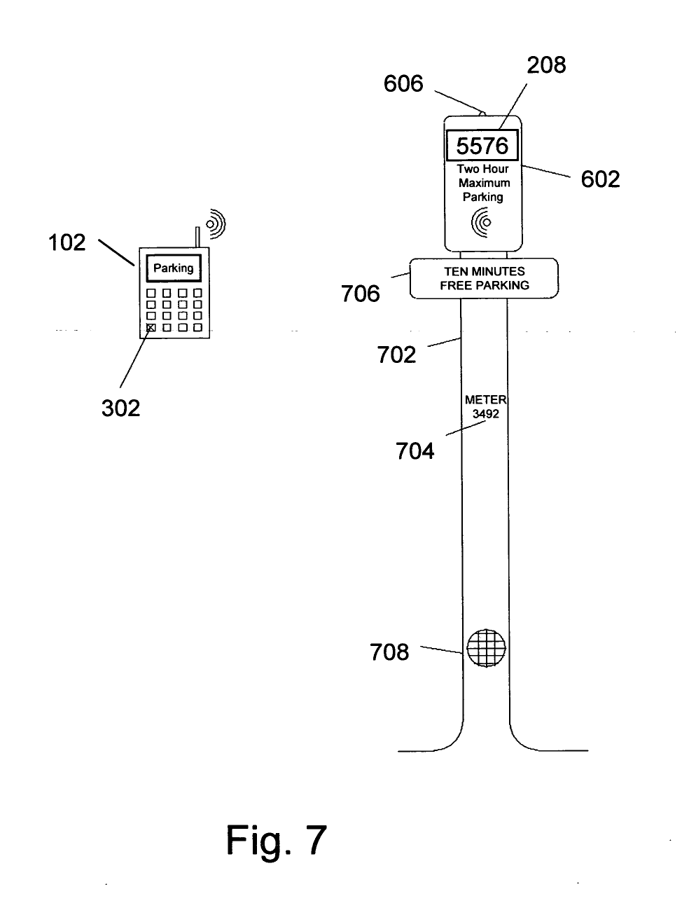

FIG. 7 shows the meter 602 on a pole 702 with a meter number 704 posted on the pole 702. In one embodiment, the meter number 704 may be from a block or group of meter numbers wherein the meter number 704 identifies the particular meter being used. The meter identification number 704 may be an alphanumeric string including letters, symbols, or punctuation as well as numeric characters. Also shown is a sonar detector 708 for detecting the presence or absence of an automobile. A parking information sign 706 may indicate information of interest. Also shown is a short range wireless link enabled cell phone 102 in communication with the meter using the short range wireless link 204.

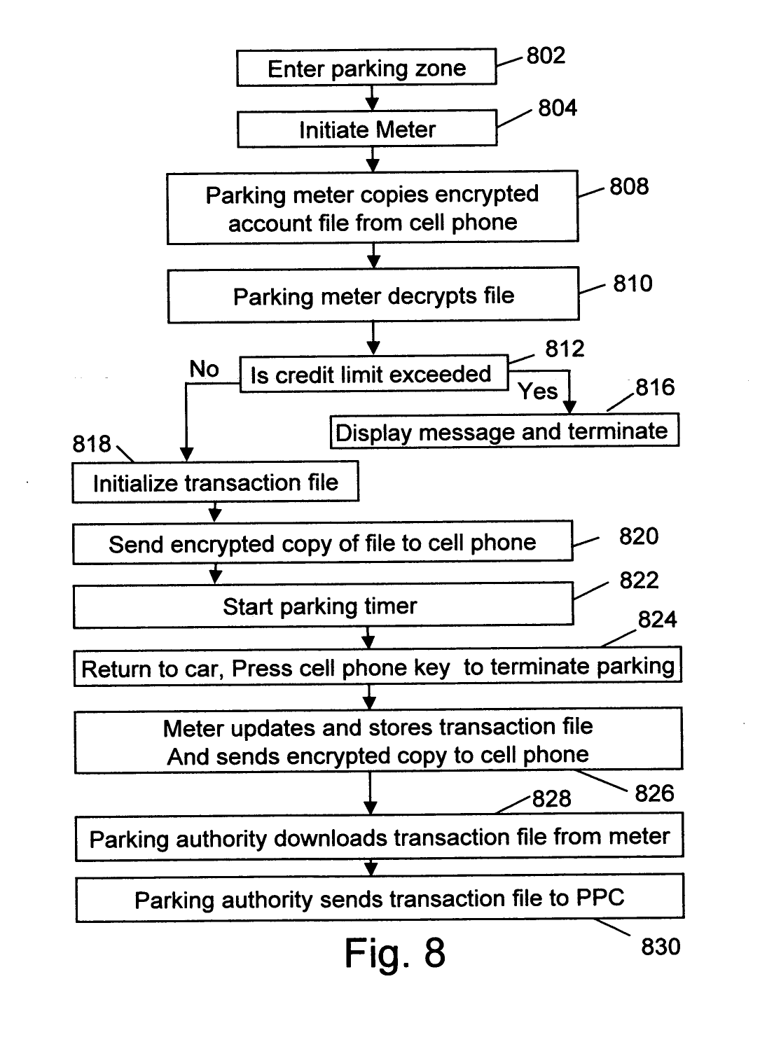

FIG. 8 is a flow chart illustrating the steps required for utilizing the present invention to both park and exit a street parking meter. Prior to parking, the user establishes an account with the PPC associated with the parking authority. PPC accounts may be as previously discussed with reference to FIG. 4.

Referring to FIG. 8, the user enters 802 the parking zone and parks the automobile. The user then enables the parking feature of the cell phone. In one embodiment a dedicated key may be provided for parking. In another embodiment, the user presses the fingerprint reader or enters a PIN. The user then selects the parking mode on the cell phone and presses a park key 302 on the cell phone to activate 804 the parking meter. By pressing the park key 302 the user places the cell phone's short range wireless transceiver in a discovery mode which will then authorize the parking meter 602 to interrogate the cell phone's memory where the encrypted payment account file is maintained. A copy of file is then moved 808 to parking meter and decrypted 810 to expose the file contents. The file contents may contain, by way of example and not limitation:

| | | |
|---|---|---|
| 1] | Cell Phone Number | 451 284 6298 |
| 2] | Account # | 48839723037 |
| 3] | Credit Limit | $25.00 Based on credit history/FICA score |
| 4] | Date/Time/Stamp | 9/6/2006 9:18:26 PM |
| 5] | Purchase Amount | $5.45 |

If a credit limit is exceeded 812, a message will be displayed and parking prohibited 816. If funds are available, the transaction file will be started 818 and a copy sent to the cell phone 820 to indicate how much time is available.

The meter 602 will then start 822 the meter's parking time clock 212 for the maximum amount of time available for that meter 602, as assigned by the parking authority. When finished parking, the user presses 824 the park key 302 again to stop the clock and terminate the charging. (In one embodiment, the park key 302 may be a dedicated key 302.) The meter 602 will update 826 the users file with the amount of parking time, the cost, and a date stamp, and then encrypt the file. An encrypted copy of the file is then sent back to the user's cell phone for storage. The meter will maintain the meter's copy of the file until the parking authority downloads 828 the file during a regular meter patrol visit. Since the wireless link has a range of typically 10 meters, the parking authority need only drive by to download files from the meter and update the meter. Upon returning to the office, the parking authority may then send 830 the files to the PPC for payment. In one embodiment, the parking authority may act as the PPC.

If the user vacates the parking space without pressing the park key and terminating the parking time, the meter's sonar detector 708 will detect the auto leaving, then close the account with the correct charges. The user will be required to call the PPC 110 on some schedule based on their payment history to send the payment files accumulated on their cell phone and to update spending limits in the account data file. The PPC 110 may compare files downloaded from the cell phone 102 with files downloaded from the parking meters 602.

### Multi Space Parking Meters

Some locations may use multi space meters to cut down on vandalism, and save on manufacturing cost. With a multi-space meter, one meter may serve a group of parking spaces or a whole parking lot. To use the invention with a multi-space meter, one follows the steps of FIG. 8 for a street parking meter with the additional step of entering a space number. One may then receive a receipt to be placed on the dash of the car indicating electronic payment of parking time. Upon returning to the car, one may again use the short range wireless link to terminate parking time and complete the charges.

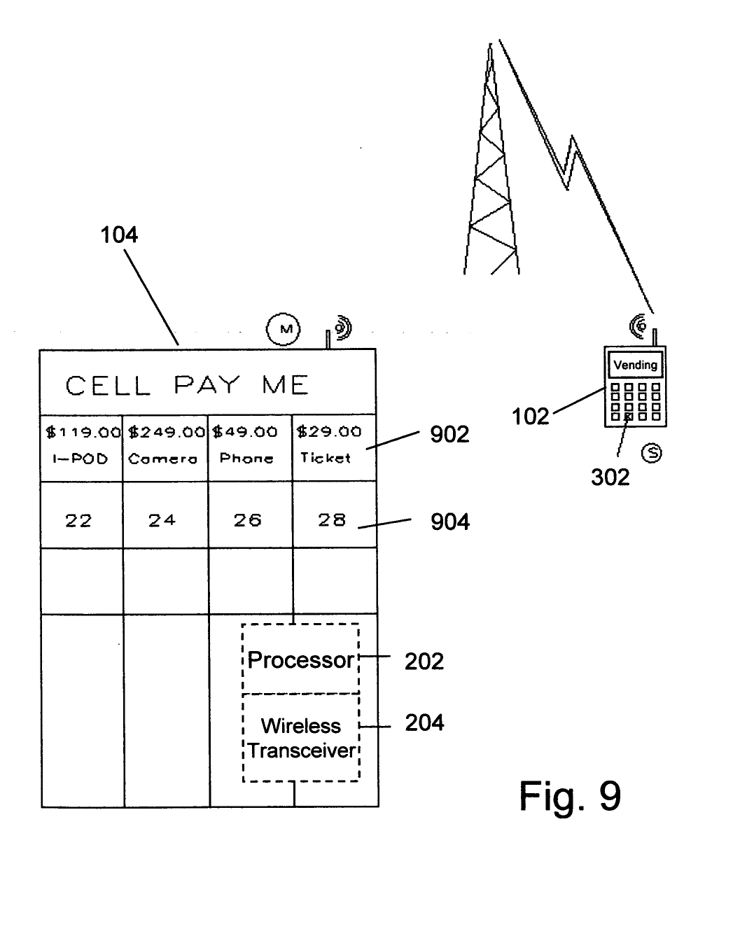

FIG. 9 shows a vending machine that vends high priced items such as cameras, cell phones, perfume and over the counter drugs. Referring to FIG. 9, the vending machine 104 displays the item 902 and an item number 904 that may be used to select the item 902 using the cell phone 102. Selection methods may be as described with reference to FIG. 3. When a user makes a purchase from the vending machine 104 of FIG. 9, the user's credit limit may be exceeded. After pressing the vend key 302 on cell phone 102 the machine 104 will interrogate the users file for credit availability. If it is not sufficient for the purchase the vending machine may dial the PPC via the user's cell phone 102 to get authorization for additional funding for the users account. If additional funding is granted by the PPC the machine 104 will vend the item. If no funding is available the machine 104 will close the account and terminate the short range wireless connection.

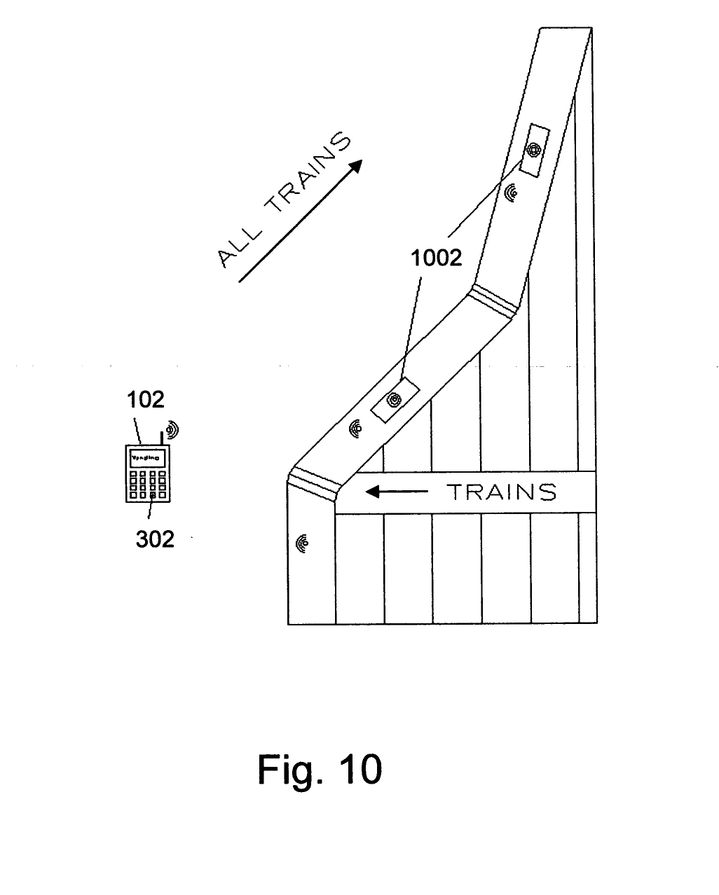

FIG. 10 illustrates the entry way to a public transportation system that has short range wireless readers for issuing tickets. The user sets up an account with the PPC and activates the cell phone as described with reference to FIG. 4. Referring to FIG. 10, the user enters the station and may activate the cell phone's transportation software by pressing a key 302 on the short range wireless enabled cell phone 102. The user then passes the cell phone 102 over the reader 1002 on the walk way railing. The reader 1002 copies and decrypts the account file from the cell phone 102 to see the available credit limit. In one embodiment, the short range wireless transceiver will make a one time charge to the account file then encrypt the file and send it back to the cell phone 102 and allow passage. In an alternative embodiment, the reader 1002 will open a transaction account, which may be used to travel to an unknown location in the transportation system where the transaction account may be closed when exiting the system, with the total dollar amount added to the cell phone account file at that time.

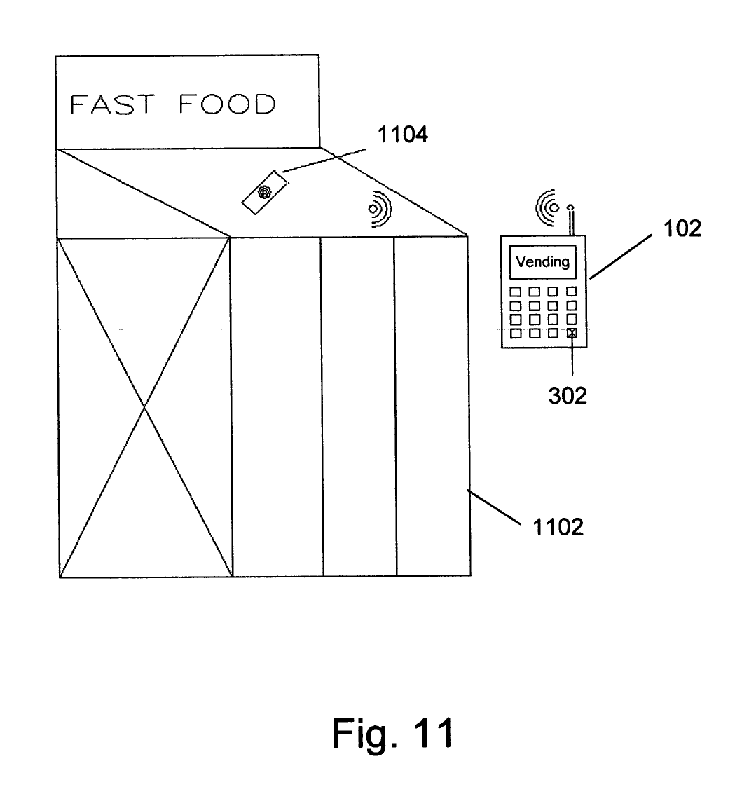

FIG. 11 illustrates a fast food restaurant 1102 with a short range wireless transceiver connected to a Point of Sale (POS) system 1104 for processing food orders for both over the counter and drive through. Food is ordered and delivered to the customer according to the normal process for the restaurant. Payment, however may be done by cell phone 102 using the PPC account.

Restaurants and other retail establishments may also receive funds from customers to be credited to the PPC account to increase the account's spending limit.

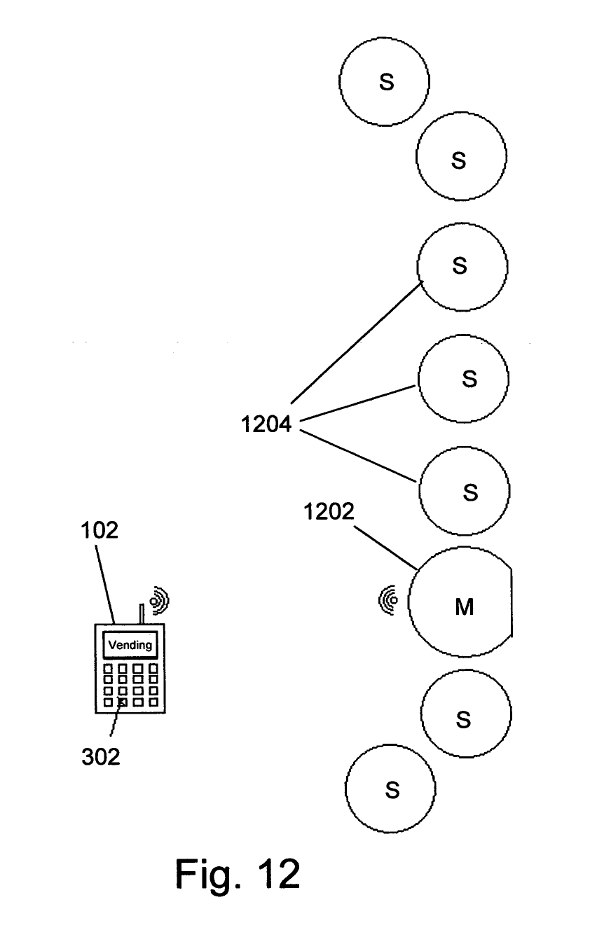

FIG. 12 illustrates a piconet interconnecting a group of vending machines being approached by a buyer with a cell phone. A piconet is a short range wireless network, for example, a Bluetooth® piconet. Referring to FIG. 12, the piconet comprises a master vending machine 1202 and a group of slave vending machines 1204. The piconet wireless protocol may be the same or may be a different protocol from the wireless link 204 connecting the cell phone 102 to the master vending machine 1202.

When the cell phone 102 enters the vending machine area and initiates communications with the master vending machine 1202, the cell phone 102 gains access to any vending machine 1202, 1204 in the network. The cell phone 102 may view all product selections or may view a particular machine's product selections.

In one embodiment, all machines are capable of communicating with the cell phone and with one another on the piconet because the piconet uses the same short range wireless access protocol as the cell phone.

To reconcile accounts at the PPC, the user may press a key on the cell phone 102 to initiate a call to the PPC, or preferably the cell phone may automatically make the call after communications is lost with the vending machines. This call may be made after each visit to the vending area or after a prescribed dollar amount has been spent, or after some number of visits set by the PPC based on the credit history of the account holder. This call may also send additional information such as date, or shortage on an item, or the outage of a machine in the vending complex.

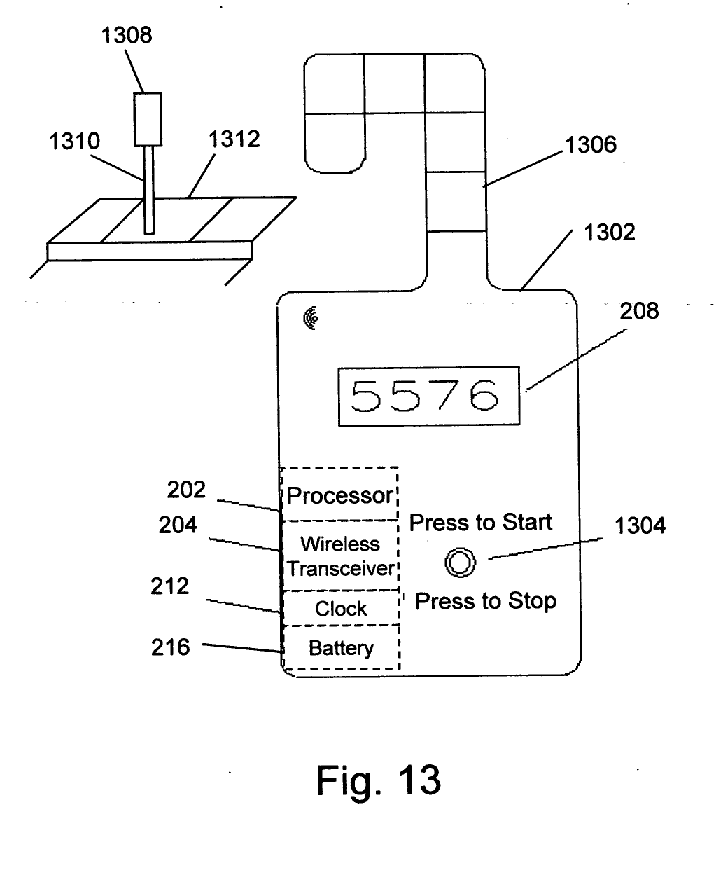

FIG. 13 illustrates an in-car parking meter in accordance with the present invention. The in-car parking meter 1302 is a device that may be displayed from the inside of a car to indicate parking time. The in car parking meter 1302 comprises a clock 212 for maintaining parking time, a processor 202, a display 208 for displaying parking time and other information, a short range wireless transceiver 204, and a battery 216. The in car parking meter may have a hanger 1306 to hang the meter on a rear view mirror.

To start parking, the user may press the parking key 1304 on the in-car meter 1302. The meter 1302 may display the remaining time on the display 208. The remaining time and meter number may alternately be displayed on the display 208. To stop the meter, the user may press the start/stop button 1304. The meter 1302 may be affixed to or permanently mounted in the automobiles infrastructure or kept in the glove compartment.

A receiving unit 1308 for communicating with the in-car parking meter 1302 may be mounted on a sidewalk 1312 pole 1310, in an existing parking meter, or imbedded inside the sidewalk or other convenient location. The receiving unit 1308 will make a copy of the account in the in-car meter 1302 of FIG. 13. The parking authority may then download the account copy when making routine meter patrol visits. The account copy may then be presented to the PPC 110 for payment.

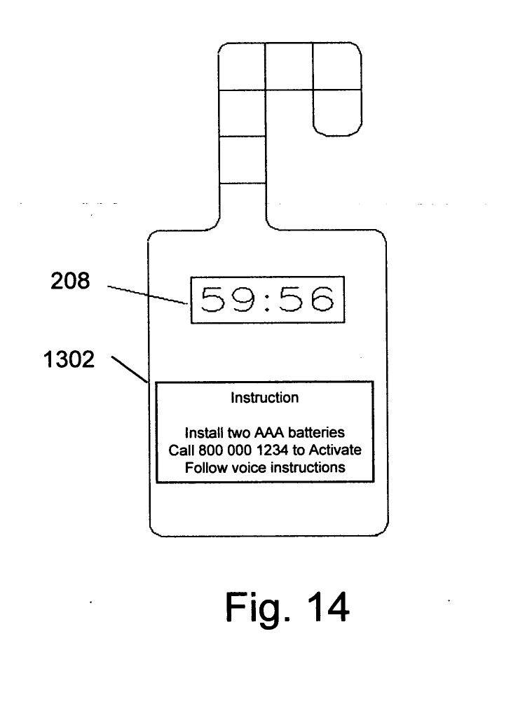

FIG. 14 shows the rear view of FIG. 13 with display alternately displaying the remaining time and the meter number.

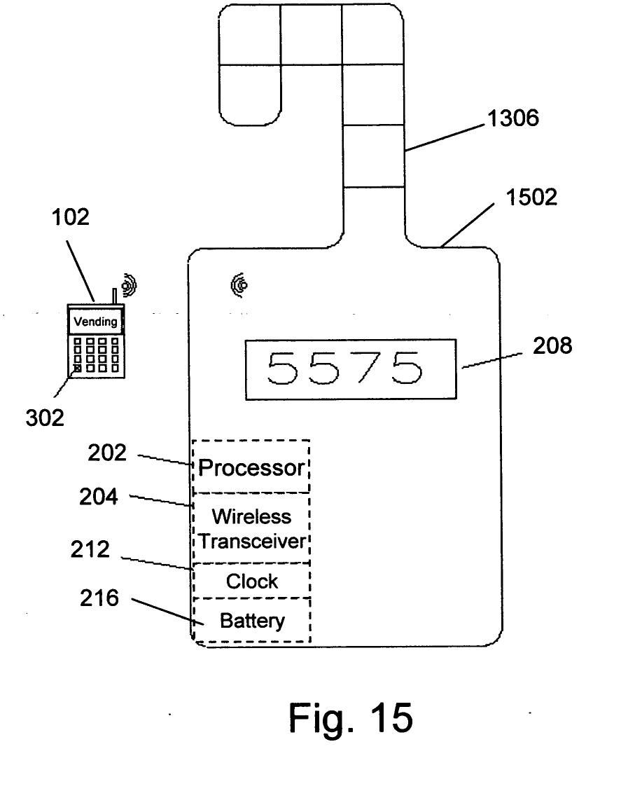

FIG. 15 illustrates an alternative in-car meter in accordance with the present invention. Referring to FIG. 15, the meter 1502 of FIG. 15 may be controlled by using the short range wireless link enabled cell phone 102. The cell phone 102 is activated as described with reference to FIG. 8, and the parking function is selected. The meter 1502 may be activated by the cell phone 102 by pressing the park key 302.

A receiving unit 1308 (see FIG. 13) for communicating with the in car parking meter 1502 may be mounted on a sidewalk pole, in an existing parking meter, or imbedded inside the sidewalk. The receiving unit 1308 will make a copy of the account of the in-car meter of FIG. 15. The parking authority may then download the account copy when making routine meter patrol visits. The account copy may then be presented to the PPC 110 for payment. The meter may display the meter number and remaining time for parking.

One advantage of a wireless, particularly a radio based wireless link is that it may operate through ice and snow. In one embodiment, the in-car parking meter may include a laser or other light source mounted on the underbelly of the car to indicate parking status. Since the underbelly would be exposed during snow of a few inches, the light would be visible.

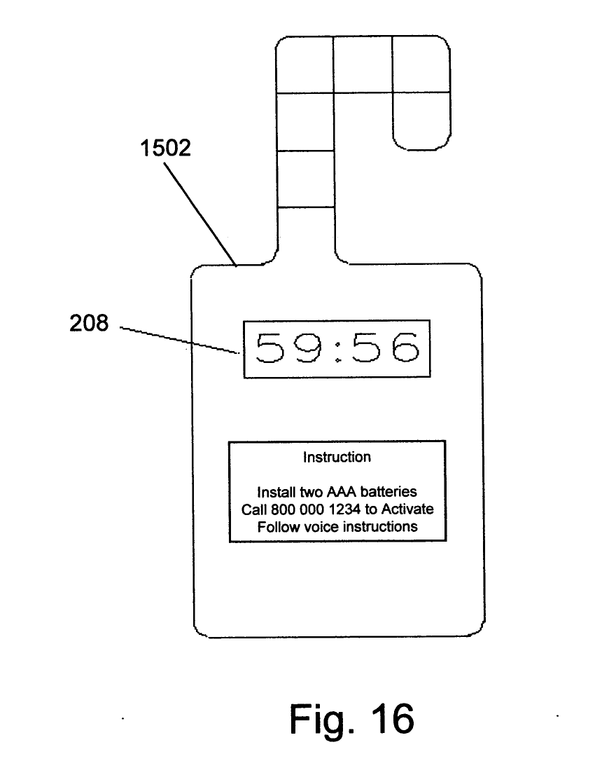

FIG. 16 shows the rear view of FIG. 15 with display alternately displaying the remaining time and the meter number.

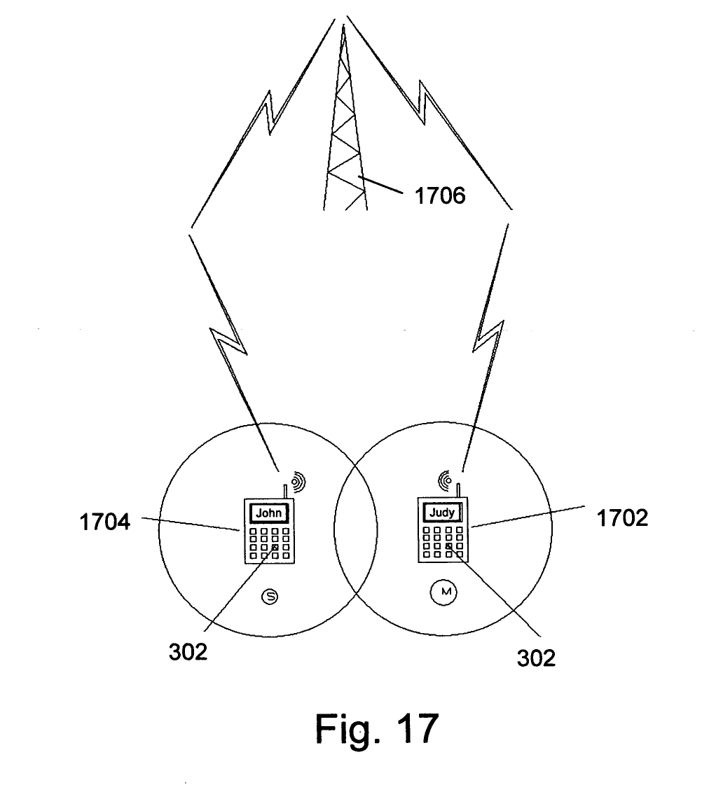

FIG. 17 illustrates an exchange of money by two users with short range wireless link enabled cell phones 102 in conjunction with a cellular tower 1706. In one embodiment, a first user contacts the PPC with a first cell phone 1702 for permission to send money to a second user using a second cell phone 1704. The PPC sends the first user and the second user an exact frequency to use and at an exact time.

The transactions may be completely anonymous by using an account number when contacting the PPC rather than the depending on the cell phone number. Each cell phone user may have a unique ten-digit account code or number. The customer should be the master of the two and initiate the call to the PPC. Before departing and exchanging the purchased item both cell phones should reflect the dollar amount exchanged with updated account information from the PPC. This feature may be used by small merchants where no POS system is in place that contains a short range wireless transceiver. For example, a merchant and customer at an outdoor garage sale may use the present system. When the customer departs there is no remaining contact information, just as if the customer paid cash.

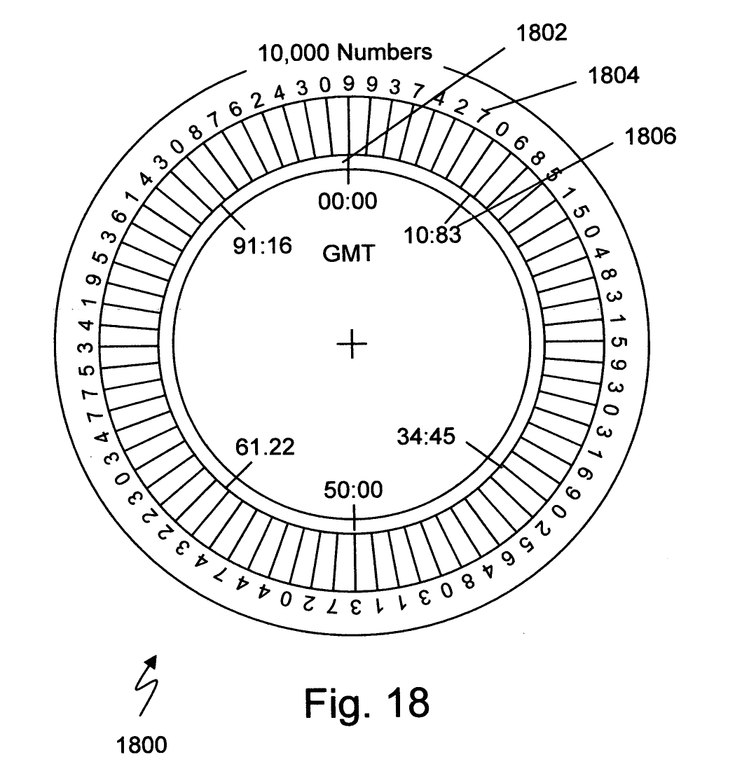

FIG. 18 through FIG. 25 illustrate an encryption method based on a PIN, which may be used with the short range wireless link of the present invention.

FIG. 18 shows an exemplary code table 1800. The code table 1800 contains 10,000 randomly selected one digit numbers (0-9). Each number 1804 has an associated four digit code number which may range from 0000 to 9999. Each vending machine contains the same code table. The table 1800 shown has 72 single digit values 1804 shown for simplicity. A start position 1802 is shown for 00:00 GMT. Other code table positions 1806 are shown. The code table 1800 rotates clockwise one position each minute. The code table rotations start at a designated time, for example: 00:00 GMT, Greenwich Mean Time. The start position of the wheel is a start PIN for the customer, i.e., the code table is first rotated so that the start PIN is at the top of the wheel. The start position for a vending machine is as determined by the PPC. All vending machines start at the same location and time. The process continues until the time of the transaction.

At the time of transaction, the transaction data to be encrypted are centered around the start PIN and summed with the corresponding outside ring random numbers. The resulting sum is transmitted along with the PIN. The receiving end decrypts the data by rotating the table according to the PIN and subtracting the corresponding outside ring random from the received data.

When the data are encrypted, synchronizing data are appended to the beginning and end of the data to verify the timing. Since some vending machines may run independently of a clock source, some clock drift may occur. The synchronizing data may be used to verify timing by trying timing one or two minutes earlier or later to find the timing that produces the correct synchronizing data. When the correct timing is found, the vending machine clock may be adjusted to correct for drift since the cell phone clock will be set by the network traceable to a time standard.

In a preferred embodiment, all vending machines and parking meters will start the code table wheel at the same position at the same GMT time. Each cell phone account will start on a unique position or on a unique GMT time.

By pressing the vending/parking key on cell phone the user will move the cell phone's code wheel to the current GMT time to match vending machine's code wheel time.

After each purchase the vending machine or parking meter will leave the cell phone's code table location intact if the credit amount has not been used up. If the amount has been reached or exceeded the vending machine will move the cell phone's code table rotation by some known factor that only the PPC will be privileged to, which renders the account inoperable.

When the customer runs out of funds in the PPC account on the cell phone, the customer may call the PPC and make arrangements, such as a credit card payment, to fund the PPC account. Alternatively, the customer may visit a retailer connected with the system to add funds to the PPC account.

The PPC may then call the cell phone to recalibrate the cell phone's code table and add additional funds to the account information stored in the cell phone.

In an alternative embodiment using an alternative encryption method, a passkey can be established by using 19:44 & 5150-4831 from above. In particular, using a Bluetooth® or similar transceiver link, pairs of devices may establish a trusted relationship by learning a shared secret known as the passkey. A device that wants to communicate only with a trusted device can cryptographically authenticate the identity of the other device. Trusted devices may also encrypt the data that they exchange over the air so that no one can listen in. The encryption can however be turned off and passkeys are stored on the device's file system and not the Bluetooth® chip itself. Since the Bluetooth® address (Every Bluetooth device has a unique 48-bit address.) is permanent, a pairing will be preserved even if the Bluetooth name is changed. Pairs can be deleted at any time by either device. Devices will generally require pairing or will prompt the owner before it allows a remote device to use any or most of its services.

Further alternative encryption methods may be used with the present invention as are know by one skilled in the art.

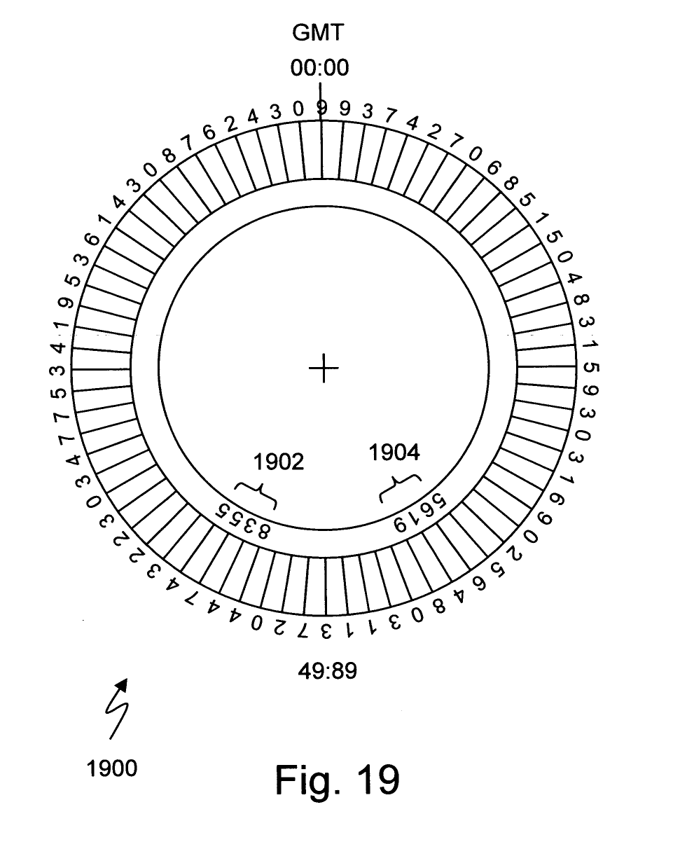

FIG. 19 shows a vending machine code table 1900 and shows a first synchronizing data sequence 1902 and a second synchronizing data sequence 1904. The vending machine is shown with a reference location 49:89. The reference location will be assigned the GMT time of 00:00. All vending machines will be set to the same location. The correct GMT time for new vending machines will set by the installer calling the PPC for a number to input into the machine when it is set up at the location.

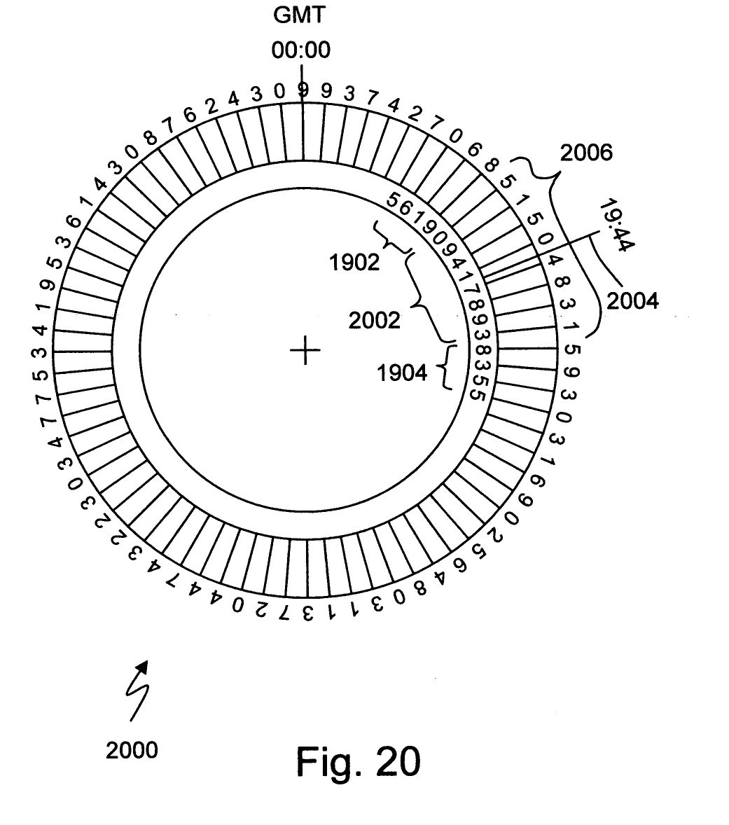

FIG. 20 shows a first cell phone code table 2000 with a first cell phone account number 2002 being encrypted with a PIN 2004 of 19:44. FIG. 20 also shows the first synchronizing data sequence 1902 and the second synchronizing data sequence 1904. Each cell phone user will have a vending mode PIN (typically a four digit number) which is required to be input into cell phone in order to activate the VEND Key. The vending mode PIN is separate from the PIN 19:44 of FIG. 20. If phone is lost/stolen, a call to the PPC to report the lost cell phone can deactivate the payment account. The PPC or user can call the lost cell phone and entering a special code to deactivate the vending function of the cell phone.

Reference 1902 & 1904 (5619-8355) are the synchronization numbers used to determine correct timing.

Reference 2002 (09417893) are the unique eight digit account numbers assigned to cell phone number one by the PPC.

Reference 2006 (5150-4831) are the outside numbers from the 10,000 at that point in GMT time determined by their PIN 19:44, reference 2004.

When the cell phone user types in the user's four digit vending PIN (which activates their VEND key) the user's cell phone's transceiver will send the user's internal PIN (19:44) plus the synchronization numbers 5619-8355 and account numbers by sending the sum of the synchronization numbers and account numbers with the corresponding outside numbers 5150-4831 which is its current GMT time location.

The vending machine will move backwards in time by the amount of the cell phones PIN (1944) from its current GMT location.

It will now compare the eight digit code (5150-4831) it received from the cell phones transceiver to the location that it moved to by the PIN 19:44.

If a match is found the vending machine will move to the next step.

The cell phone user will not be privileged to the internal PIN (19:44) and the eight digit code (5150-4831) since they may change after each use or after some time frame.

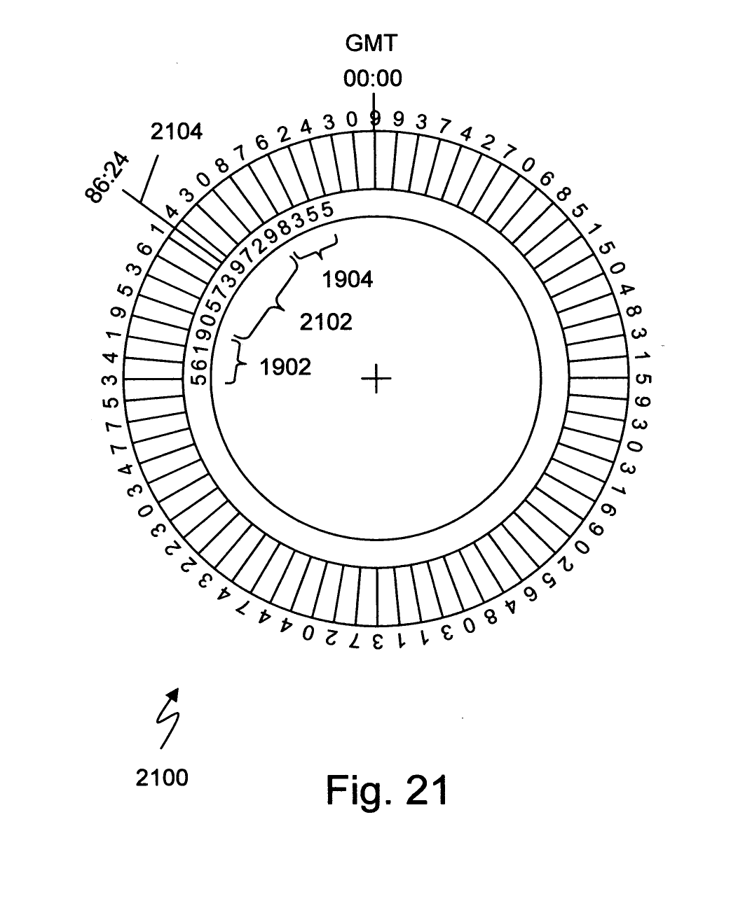

FIG. 21 shows a second cell phone code table 2100 with a second cell phone account number 2102 being encrypted with an internal PIN 2104 of 86:24. FIG. 20 also shows the first synchronizing data sequence 1902 and the second synchronizing data sequence 1904.

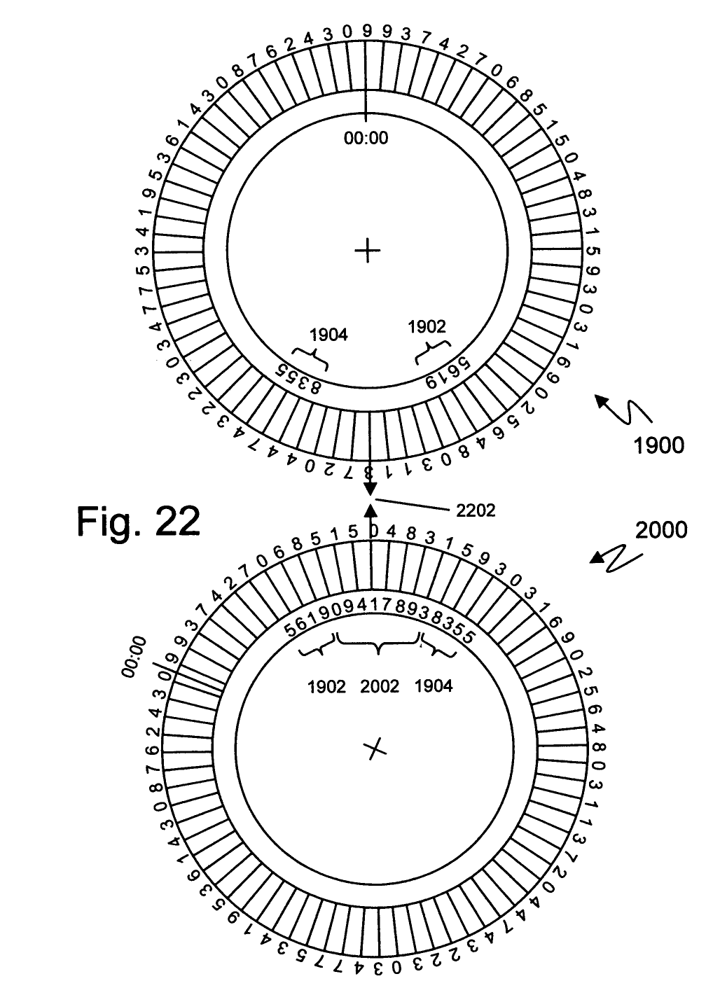

FIG. 22 shows the first cell phone account number being decrypted at the vending machine and shows alignment 2202 of the vending machine code table 1900 and first cell phone code table 2000.

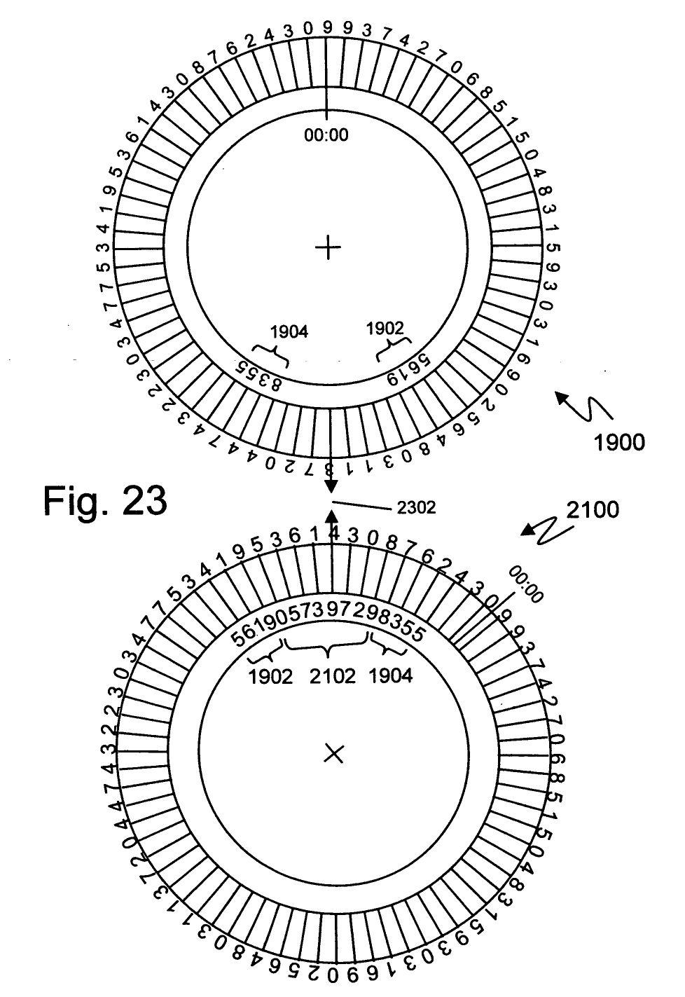

FIG. 23 shows the second cell phone account number being decrypted at the vending machine and shows alignment 2302 of the vending machine code table 1900 and second cell phone code table 2100

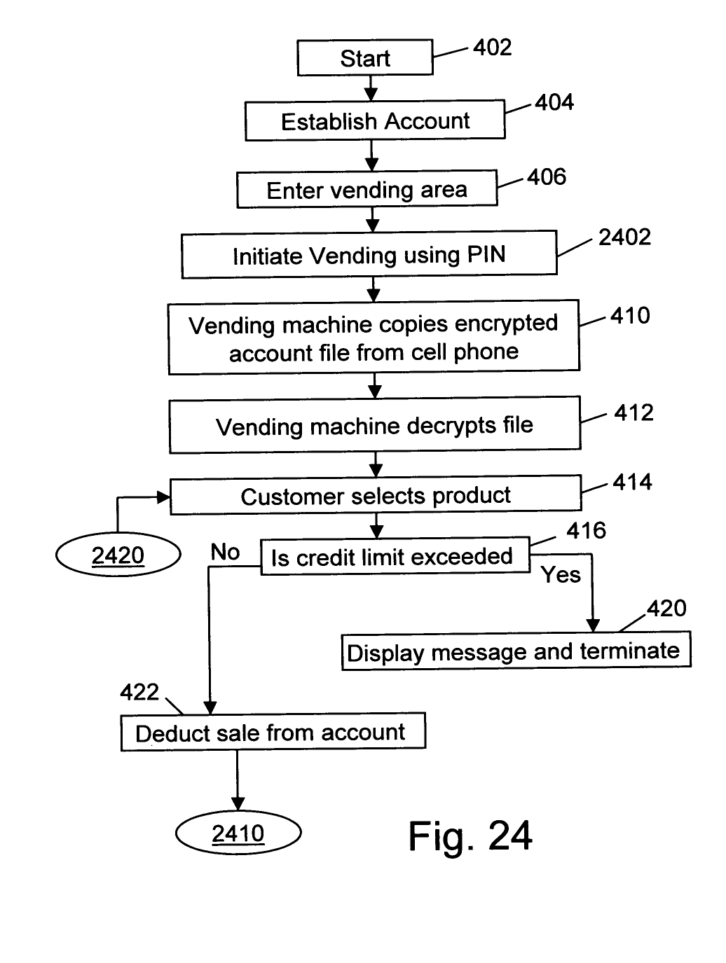

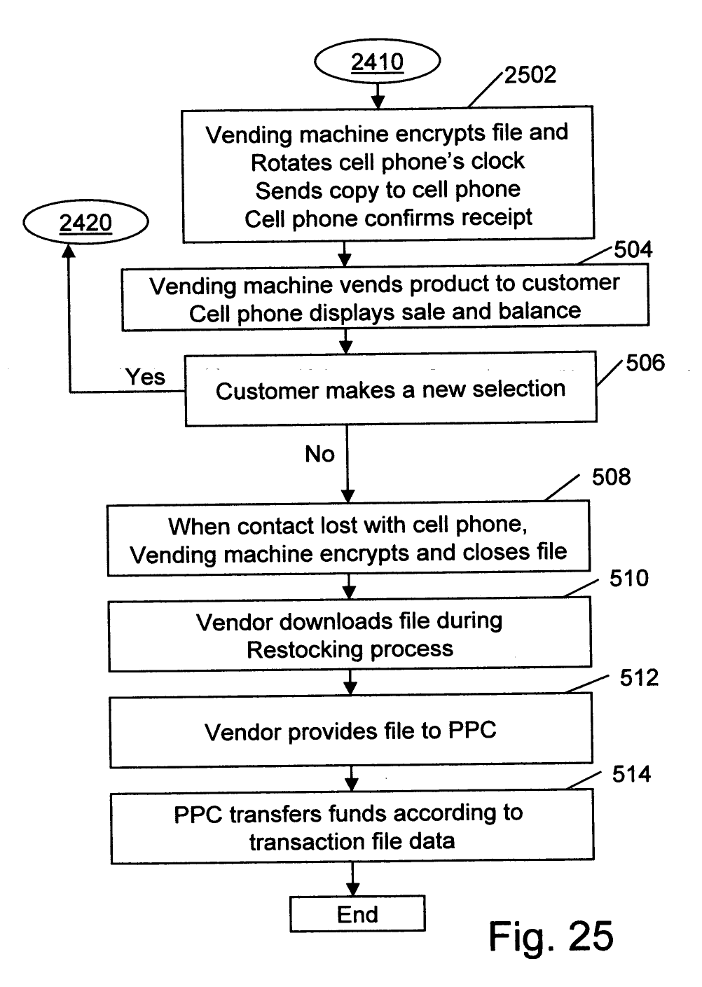

FIG. 24 and FIG. 25 illustrate exemplary steps for operating a vending machine using a PIN in accordance with the present invention. Referring to FIG. 24, many of the steps are similar to the steps described with reference to FIG. 4 and FIG. 5, as can be inferred from the use of the same reference number. One difference is reflected in step 2402. Vending is initiated by entering a vending PIN. The vending PIN is used to enable the encryption of the transaction data. Also, in FIG. 25, 2502, the cell phones clock must be reset by PPC after each vending operation. In the process of FIG. 24 and FIG. 25, the vending operation is performed without a cell phone call on the cell network. Cell phone calls may be performed later at some convenient time to reconcile accounts.

In an alternative embodiment, the vending process is followed immediately with a reporting cell phone call to maintain records current. The steps of an exemplary process are as follows: The user presses a vend key on the cell phone, which sends a stored PIN to the vending machine. The vending machine then delivers the product. After communications is lost with vending machine or dollar amount is exhausted, the cell phone automatically calls a number, for example 800 000 8273, which is the vending machine's account number. The cell phone may then call another number, for example 800 000 0065, to report the amount of purchase. The cell phone may then call another number, for example 800 000 9381, to report the item purchased. The PPC may then call the cell phone from a particular number, such as 800 000 3481, which is used to reset the encryption code table and PIN for next vending operation. The cell phone user will thus not be required to remember any PIN. This process allows the PPC to instantly move funds from the cell phones account to the vending machine's account and keep track of the vending machine's inventory. This process will also allow a retail establishment to add money to the cell phone's account.

### Conclusion

One should understand that numerous variations may be made by one skilled in the art based on the teachings herein. Such variations include but are not limited to variations in color scheme, label text, placement and size of controls, and number of controls. The exact function of controls may be varied within a class of similar functions.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

1. A system for vending a product or service comprising:
an account at a payment processing center;
a cell phone, said cell phone comprising a memory containing account information relating to said account and further comprising a first short range wireless transceiver; and
a vending machine, said vending machine comprising a second short range wireless transceiver for communication with said cell phone, and said vending machine further comprising a vending machine memory;
wherein said cell phone sends said account information to said vending machine, said vending machine receives a product selection, said vending machine records sale transaction information in accordance with said account information and said product selection, said recording being directed to said vending machine memory, and said vending machine delivers said product or service in response to said product selection;
said system further including a storage device for transferring and storing said sale transaction information from said vending machine memory at a time after the delivery of said product;
said sale transaction information further transferred to said payment processing center from said storage device for applying said sale transaction information to said account;
wherein a copy of said sale transaction information is transferred to said cell phone and subsequently transferred to said payment processing center through a cell phone network for comparing with said sale transaction information transferred from said storage device to said payment processing center.

2. (canceled)

3. The system as in claim 1, wherein said vending machine comprises a food vending machine or a beverage vending machine.

4. The system as in claim 1, wherein said vending machine comprises a parking meter.

5. The system as in claim 4, wherein said parking meter is an in-car parking meter.

6. The system as in claim 1, wherein said vending machine delivers passage on public transportation.

7. The system as in claim 1, wherein said account information sent to said vending machine from said cell phone is a copy of an encrypted file in said cell phone, said vending machine decrypts said copy of said encrypted file and updates said account information in accordance with said sale transaction information to produce an updated account file, said updated account file is encrypted by said vending machine to produce an encrypted updated account file and a copy of said encrypted updated account file is sent to said cell phone using said second short range wireless transceiver, said cell phone sending said copy of said encrypted updated account file to said payment processing center after delivery of said product or service; said payment processing center transferring funds in accordance with said copy of said encrypted updated account file.

8. The system as in claim 7, wherein said updated account file is encrypted by said vending machine using fingerprint information delivered to said vending machine from said cell phone.

9. The system as in claim 7, wherein said account information is encrypted using a personal identification number.

10. The system as in claim 1, wherein said sale transaction information is generated by relying on said account information without contemporaneous communication with said payment processing center.

11. The system as in claim 1, wherein said account information includes a spending limit.

12. The system as in claim 1, wherein said account information is updated in accordance with said sale transaction information without contacting said payment processing center.

13. The system as in claim 12, wherein said account information is updated by said vending machine to produce updated stored account information and said updated stored account information is transmitted to said cell phone prior to said vending said product or service.

14. A method for vending a product or service comprising:
establishing an account with a payment processing center;
storing account information relating to said account on a cell phone;
sending said account information from said cell phone to a vending machine over a short range wireless link;
generating sale transaction information for said product or service relating to said account information;
storing said sale transaction information in said vending machine;
delivering said product or service;
retrieving said sale transaction information from said vending machine using a memory device;
delivering said sale transaction information to said payment processing center for debiting said account, wherein at least one link of said delivering said sale transaction information includes physical transportation of said memory device;
delivering a copy of said sale transaction information to said cell phone; and
delivering said copy of said sale transaction information from said cell phone to said payment processing center via a cell phone network after said delivering of said product or service.

15. (canceled)

16. The method of claim 14, wherein said step of sending said account information from said cell phone includes the steps of copying an encrypted account file in said cell phone and sending said copy of said encrypted account file to said vending machine;
said method further comprising the steps of:
decrypting said copy of said encrypted account file by said vending machine to expose said account information;
updating said exposed account information with said sale transaction information to produce updated account information;
encrypting said updated account information to produce encrypted updated account information;
sending said encrypted updated account information to said cell phone;
said cell phone subsequently sending said encrypted updated account information to said payment processing center; and
said payment processing center transferring funds in accordance with said encrypted updated account information.

17. The method of claim 14, wherein said sale transaction information is generated by relying on said account information without contemporaneous communication with said payment processing center.

18. The method of claim 17, wherein said account information includes a spending limit.

19. The method of claim 14, further including the step of:
updating said account information in said cell phone in accordance with said sale transaction information.

20. The method of claim 14, further including the steps of:
updating said account information by said vending machine in accordance with said sale transaction information to produce updated account information; and
sending said updated account information to said cell phone.

21. The system of claim 1, wherein inventory information from said vending machine is sent to said cell phone and said cell phone sends said inventory information to said payment processing center at a time after said vending of said product or service.

22. The system of claim 1, wherein said cell phone is out of range for cell phone network coverage at the location of said vending of said product or service, and said cell phone transmits said account information to said payment processing center after returning to a location where said cell phone network coverage is available.
